(19) United States
(12) Patent Application Publication
(10) Pub. No.: US 2025/0061754 A1
(43) Pub. Date: Feb. 20, 2025

(54) METHOD AND APPARATUS FOR MONITORING A THERMAL DEGRADATION OF A REDUCING SOLUTION

(71) Applicant: ERRECINQUE S.R.L., Mappano (IT)

(72) Inventors: Mario Incardona, Mappano (IT); Matteo Bolzoni, Mappano (IT)

(21) Appl. No.: 18/719,453

(22) PCT Filed: Dec. 21, 2022
(86) PCT No.: PCT/IB2022/062574

§ 371 Date: Jun. 13, 2024

(30) Foreign Application Priority Data
Dec. 21, 2021 (IT) 102021000032027

(51) Int. Cl. G07C 5/08; F01N 3/20

(52) U.S. Cl. CPC G07C 5/0808; F01N 3/208; G07C 5/0825; F01N 2610/02; F01N 2610/1406; F01N 2900/1811

(57) ABSTRACT

A method for monitoring a thermal degradation state of a reducing solution contained within a reservoir includes the steps of providing a first functional relationship associating a quantity indicative of a temperature of the solution with a first parameter associated with the thermal degradation state, acquiring the quantity, and determining the first parameter as a function of the acquired quantity via the first functional relationship, wherein the degradation state is monitored based on the first determined parameter. The first functional relationship comprises an increasing function of a product between the running time and an increasing coefficient with said quantity of the temperature.

### CROSS-REFERENCE TO RELATED APPLICATIONS

This Patent Application claims priority from Italian Patent Application No. 102021000032027 filed on Dec. 21, 2021 the entire disclosure of which is incorporated herein by reference.

### TECHNICAL SECTOR

The present invention concerns a method and an apparatus for monitoring a thermal degradation state of a reducing solution contained within a reservoir, in particular a vehicle, more particularly comprising a compression-ignition engine.

Usually, a vehicle provided with a compression-ignition engine also includes an after-treatment system for the exhaust gases produced by the engine.

In some cases, the system comprises a selective catalytic reduction device, also known by the abbreviation SCR, for reducing harmful nitrogen oxide emissions of the vehicle.

The SCR device in turn comprises an injector of a reducing solution, for example based on urea or ammonia, to spray the exhaust gases with the reducing solution.

The reducing solution absorbs oxygen from the exhaust gases, thus limiting the formation of nitrogen oxides.

Therefore, the vehicle is provided with a reservoir containing the reducing solution to feed the injector.

In addition, the reservoir has an opening in order to be replenished from time to time with a new reducing solution.

Notoriously, the reducing solution contained in the reservoir is subject to thermal degradation or decay; in other words, the efficacy of the reducing solution decreases over time as a function of the temperature of the same solution inside the reservoir.

In addition, the degrading reducing solution tends to decompose into chemical compounds that are potentially harmful for some devices that may come into contact with them.

The higher the temperature, the greater the degradation of the reducing solution.

For this reason, the reducing solution should be replaced when a high thermal degradation is reached.

However, accurately establishing a moment at which it is appropriate or necessary to replace the reducing solution, particularly taking into account any interim replenishments made, is not really straightforward.

This is clearly a critical aspect, since a failure to replace the degraded reducing solution carries the risk of damaging the components in contact with the reducing solution, while a failure to replenish leads to a reduced efficacy of the SCR, with associated damage to the environment.

### BACKGROUND OF THE INVENTION

Therefore, there is a need to address the critical aspect outlined above, preferably in a simple and cost-effective manner.

Aim of the invention is to satisfy this need.

### SUMMARY OF THE INVENTION

According to the invention, the aim is achieved by a method and an apparatus as defined in the independent Claims. The dependent Claims set forth particular embodiments of the invention.

### BRIEF DESCRIPTION OF THE DRAWINGS

For a better understanding of the invention, embodiments will be described in detail below by way of non-limiting example with reference to the accompanying drawings, wherein:

FIG. 1 is a schematic representation of a vehicle comprising an apparatus according to the invention;

FIG. 2 is a function graph expressing an experimental link between a temperature of a reducing solution and a decay time thereof;

FIG. 3 is a function graph expressing a link between the temperature of the reducing solution and a ratio of a reference decay time to the decay time of FIG. 2;

FIG. 4 is a block diagram showing steps of a method according to the invention, executable by the apparatus of FIG. 1.

### DETAILED DESCRIPTION OF THE INVENTION

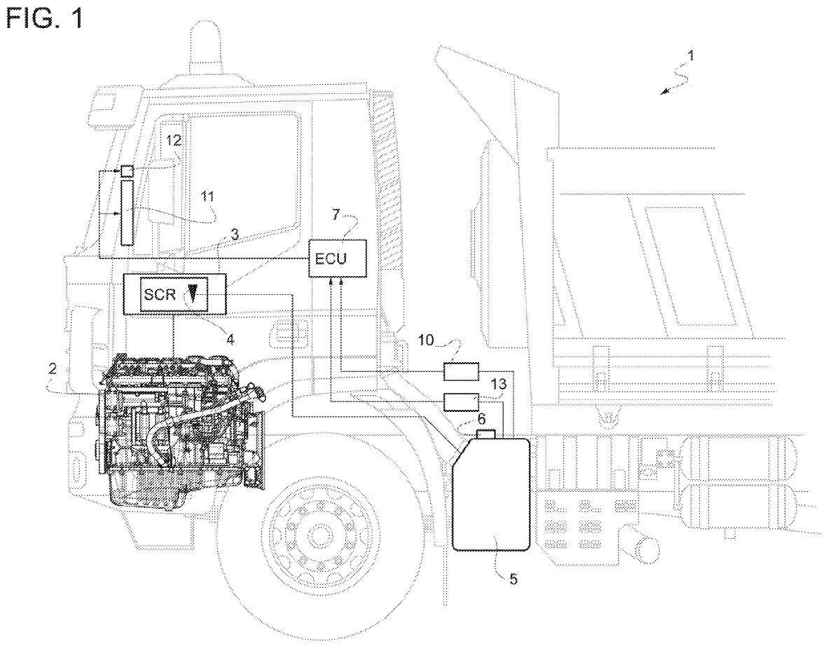

In FIG. 1, reference number 1 is used to denote a vehicle as a whole.

The vehicle 1 comprises an engine 2, specifically an internal combustion engine, more precisely of the compression-ignition type, and an after-treatment device 3 configured to treat the exhaust gases of the engine 2.

The after-treatment device 3 comprises an SCR, in turn comprising an injector 4 to deliver a reducing solution, specifically based on urea, on the exhaust gases of the engine 2.

In addition, the vehicle 1 comprises a reservoir 5 for containing the reducing solution; specifically, the reservoir 5 is connected to the injector 4 so as to allow feeding the same with the reducing solution.

The reservoir 5 has a refilling opening 6 selectively closable and suitable to allow replenishing the reservoir 5 with the reducing solution.

Clearly, the refilling opening 6 can also be used to replace the reducing solution already contained in the reservoir 5 with a new reducing solution.

The vehicle 1 also comprises an apparatus for monitoring thermal degradation state of the reducing solution a contained within the reservoir 5.

The apparatus comprises a control unit 7 programmed or configured to perform a method for monitoring the degradation state.

The control unit 7 comprises or stores a first functional relationship or function associating a quantity or variable indicative of a temperature of the reducing solution, for example the same temperature, with a first parameter associated with the thermal degradation state.

More precisely, as implied by the meaning of the term function or functional relationship, the first function or functional relationship associates a value of the quantity indicative of the temperature with a corresponding value of the first parameter.

In general, implicitly or at least in this description, any functional relationship or function associating a quantity with another quantity or parameter, more precisely associates respective values of the quantity and of the other quantity or parameter.

Therefore, in other words, the term quantity could be replaced anywhere in this description by the term value.

In the following, the quantity indicative of the temperature will be defined by the temperature of the reducing solution in the reservoir 5, without losing any generality; clearly, this temperature can be replaced throughout the text by any other quantity indicative of the same.

Conveniently, the quantity is increasing with the indicated temperature, more precisely proportional thereto.

The first parameter, in greater detail, is a decay time of the solution, in the sense that it expresses the elapsing or the evolution of the useful life of the solution.

In other words, the greater the first parameter, i.e. the decay time, the greater the degradation of the solution.

In particular, the decay time is a running time from zero incremented as a function of the temperature in a manner increasing therewith. For example, the running time is determined by the control unit 7 via an internal clock thereof.

In general, the control unit 7 is configured to determine the time, in particular the running, elapsing, or elapsed time, more particularly from an initial instant, for example equal to zero.

More precisely, starting from zero and considering a discretization of time in several next instants, the decay time in a next instant (instant k+1) is obtained by adding an increment to the decay time at the running instant (instant k), wherein the increment is given by a product between an increasing coefficient with the temperature and the time distance between the next instant and the running instant.

In particular, the coefficient is a function of the temperature at the next instant.

Taking a numerical example, the running instant at the beginning (instant zero) corresponds to a null decay time; assuming that the distance between the instants is constantly equal to 10 s, the decay time at the next instant (instant one) will be equal to ten times the value of the coefficient at the next instant, for example 15 s (coefficient 1.5). Thus, at the next instant (instant two), the decay time will be equal to 15 s plus ten times the value of the coefficient at the next instant, for example 25 s (coefficient 1).

From this, it can be deduced directly and unambigously that the coefficient is dimensionless.

All this can of course be transposed into a continuous domain of time considering an infinitesimal distance between next instants. Thus, the first parameter, i.e. the decay time, becomes precisely an integral over time of the product between the time itself and the coefficient, the latter being a generic function of time and an increasing function of temperature.

This makes it possible to derive that the first parameter, i.e. the decay time, is an increasing function of the product between the running time and the coefficient, which in turn is an increasing function of the temperature.

Thus, the first functional relationship may be defined by or otherwise comprise such increasing function of the product between the running time, i.e. the time or the elapsing time or the elapsed time (e.g. from an initial instant) in other words, and the coefficient. However, this is not necessary, so it is optional. For example, the initial instant is equal to zero.

Thus, the control unit 7 performs a method, in particular over time, for monitoring the thermal degradation state of the solution.

Therefore, obtaining the first functional relationship is correlated to obtaining the coefficient.

In greater detail, providing or obtaining the first functional relationship comprises the following steps:
providing or considering a second functional relationship or function associating the temperature with a second parameter, distinct from the first parameter but also associated with the thermal degradation state,
providing or considering a reference value of the second parameter associated with a value of the temperature representative of an ambient temperature,
providing or obtaining a third parameter, specifically defined by the coefficient, which is inversely proportional to the second parameter at least for temperature values that are greater than the ambient temperature and according to a proportionality constant defined by the reference value, and
providing or obtaining the first functional relationship as an increasing function of the third parameter, that is, of the specific coefficient.

The second parameter is decreasing as the temperature increases, according to the second functional relationship.

For example, the second parameter is a time whereby the reducing solution will reach its useful life end, i.e. a degradation limit state beyond which efficacy is considered unacceptable, assuming that the temperature remains constant throughout said time.

FIG. 2 is a graph of the second functional relationship with the temperature in abscissa and the second parameter in ordinate.

The control unit 7 comprises or stores the second functional relationship, which is preferably obtained experimentally.

In the example of FIG. 2, the reference value of the second parameter is equal to about 13000 hours corresponding to the ambient temperature equal to 25° C. Thus, the reducing solution would have an unacceptable efficacy after about 13000 hours at ambient temperature equal to 25° C.

Clearly, this is not limiting. The term ambient temperature could refer to any reference temperature of the environment outside the reservoir 5, but preferably it is understood as a temperature between 10° C. and 35° C., more preferably equal to 25° C. like in the example of FIG. 2.

For temperatures higher than or equal to the ambient temperature, the third parameter is the reference value divided by the second parameter. Therefore, since the second parameter is a function of temperature, the third parameter is also a function of temperature.

This could also have been the case for values below ambient temperature,. for all temperature values; however, specifically, the third parameter is constant with respect to temperature and more precisely equal to one for values below ambient temperature.

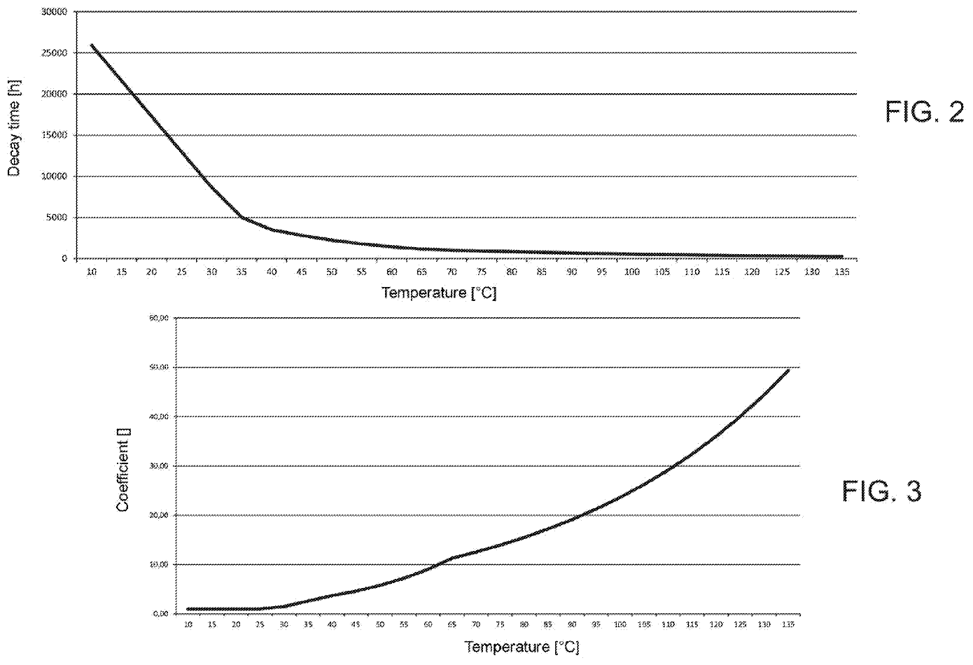

FIG. 3 is a graph showing the third parameter, that is in particular the above coefficient, as a function of temperature. More precisely, the third parameter is reported in the ordinates, while the temperature is reported in the abscissae.

As can be seen in FIG. 3, the third parameter is assumed to be equal to one for temperature values below ambient temperature.

In the present case, FIG. 3 does not show the first functional relationship. Rather, the latter is based on the coefficient or third parameter, in particular via the product of the coefficient or third parameter and the running time. More particularly, the first functional relationship may coincide with the integral over time of the latter product, as already explained above, possibly calculated in a discretized form.

The further functional relationship associating temperature with the third parameter or with the coefficient is conveniently stored in the control unit 7.

The control unit 7 is configured to acquire the temperature and determine the first parameter as a function of the temperature acquired via the first functional relationship.

In other words, the control unit 7 applies the first functional relationship to the acquired temperature, thus obtaining the first parameter.

To allow acquisition, the apparatus of the vehicle 1 preferably comprises a transducer 10 coupled in particular to the reservoir 5 and more generally configured to acquire the temperature and generate a signal associated with it.

The control unit 7 is coupled to the transducer 10, so as to receive the generated signal; furthermore, the control unit 7 is configured to acquire the signal and then the temperature by extracting it from it.

The control unit 7 is further configured to monitor the degradation state of the reducing solution based on the first determined parameter.

For example, the control unit 7 may establish the degradation state from the first parameter.

Furthermore, the apparatus may preferably comprise a display device 11 for displaying the degradation state or directly the first parameter.

The control unit 7 would control the display device 11 so that it displays the degradation state or directly the first parameter, for example.

Thus a driver of the vehicle 1 could observe the display device 11 and derive the degradation state.

Advantageously, the control unit 7 is configured to determine a critical condition of the degradation state based on the first determined parameter; more precisely, the control unit 7 determines the critical condition when the first parameter satisfies a relationship with a threshold.

In particular, the critical condition is determined when the first parameter exceeds the threshold.

The apparatus may preferably comprise a warning device 12 in order to warn the driver about the critical condition. The control unit 7 would command the issue of a warning, in particular via the warning device 12, when it determines the critical condition.

In particular, the driver learns from the warning that the reducing solution should be completely replaced.

The threshold is stored by the control unit 7 and can preferably be updated by the control unit 7, in particular as a function of replenishments of the reservoir 5, i.e. of the feedings of the reducing solution into the reservoir 5 through the refilling opening 6.

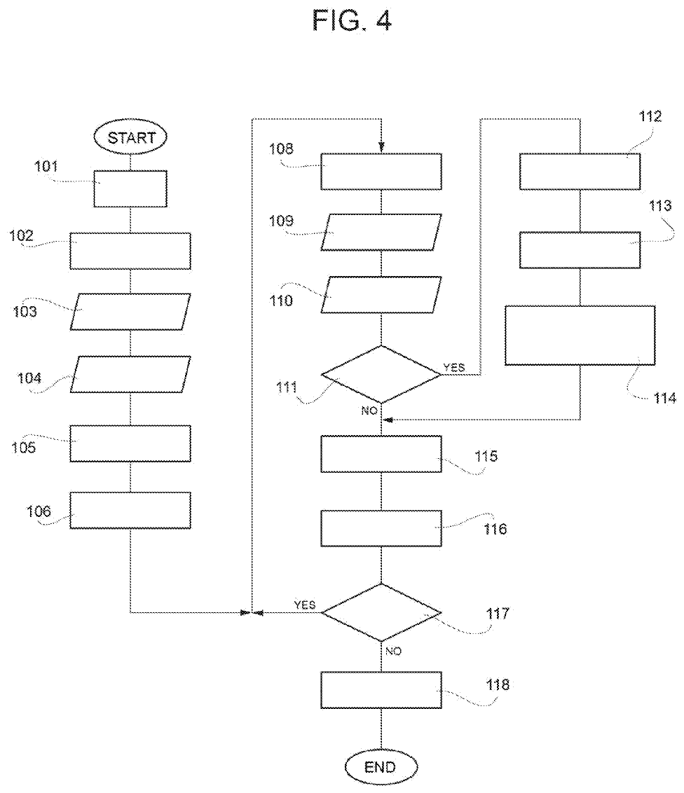

For example, at an initial instant, the threshold is set equal to the reference value of the second parameter (block 101 of FIG. 4).

Furthermore, the control unit 7 initializes a counter N, for example by setting it equal to one (block 102 of FIG. 4).

The control unit 7 is further configured to determine an occurrence of feeding an additional amount of the solution into the reservoir 5.

In other words, the control unit 7 determines the occurrence of a replenishment of the reducing solution.

The control unit 7 is also configured to determine the additional amount, as well as a base amount already in the reservoir 5 just prior to the feeding of the additional amount.

This can happen in many ways. For example, the apparatus comprises a level sensor 13 configured to detect a solution level in the reservoir 5. The control unit 7 is coupled to the level sensor 13 so as to acquire the detected solution level. Thus, the control unit 7 determines the base amount from the solution level prior to feeding and the additional amount by subtracting the solution level prior to feeding to the solution level after feeding.

In this case, the control unit 7 determines the occurrence of feeding indirectly when it evaluates that the acquired solution level has increased.

The amounts can be determined by the solution level by knowing the dimensions of the reservoir 5. The control unit 7 can store these dimensions and calculate the amounts based on the stored dimensions and on the acquired solution levels.

Otherwise, the apparatus could have comprised alternatively or in addition to the sensor 12 other sensors, such as a sensor adapted to directly measure an amount fed into the reservoir 5, in particular via the refilling opening 6.

Thus, at the initial instant, the control unit 7 can acquire the solution level or the corresponding current solution amount and possibly the temperature in association with the initial value of the counter N (blocks 103, 104 of FIG. 4: the order of the blocks is irrelevant).

Then, the control unit 7 calculates the coefficient based on the acquired temperature, in association with the initial value of the counter N (block 105 of FIG. 4).

Preferably, the control unit 7 calculates the first parameter, in association with the initial value of the counter N by multiplying the coefficient to the running time (block 106 of FIG. 4), which is meanwhile passed from zero to the value of a sampling time, for example one minute. Then, the initial value of the counter N is associated with the next instant with respect to the initial one. Alternatively, the first parameter can be set to zero, considering the running time equal to zero in association with the initial value of the counter N.

Here, the control unit 7 increments the counter to the next value (block 108 of FIG. 4).

At this point, the control unit 7 acquires the solution level or the corresponding current solution amount and possibly the temperature in association with the next value of the counter N (blocks 109, 110 of FIG. 4: the order of the blocks is irrelevant).

If the acquired solution level at the next value of the counter N is higher than the acquired solution level at the previous value of the counter N (block 111 of FIG. 4, output YES), the control unit 7 determines the occurrence of feeding.

The same would clearly be the case if the current solution amount increases in the passage of the value of the counter N from the previous to the next one.

When it determines the occurrence of feeding, the control unit 7 is configured to update the threshold as a function of the additional amount and of the base amount, which in turn can be determined based on the solution levels or on the trend over time of the current solution amount.

In particular, the control unit 7 determines a first value indicative of (more precisely equal to) the base amount divided by the sum of the base amount and of the additional amount (block 112 of FIG. 4), i.e. the total amount in the reservoir 5 just after the occurrence of feeding.

In other words, the control unit 7 determines a first value indicative of (more precisely equal to) the amount of the reducing solution in the reservoir 5 prior to the replenishment, referred to a total amount of the reducing solution in the reservoir at the end of the replenishment.

In addition, the control unit 7 determines a second value indicative of (more precisely equal to) the additional amount divided by the sum of the base amount and of the additional amount (block 113 of FIG. 4).

In other words, the control unit 7 determines a second value indicative of (more precisely equal to) the amount of the reducing solution fed into the reservoir 5 during the replenishment, referred to the total amount of the reducing solution in the reservoir 5 at the end of the replenishment.

The first and second values can be expressed as a percentage.

Thus, the update of the threshold (block 114 of FIG. 4) comprises a multiplication of the not yet updated, and therefore running, threshold by the sum of the first and second values.

Furthermore, preferably, the update also comprises subtracting a product between the first value and a multiplicative factor to the just mentioned multiplication, wherein the multiplicative factor is indicative of a time elapsed between the currently determined occurrence of feeding and the just preceding one. Clearly, if the currently determined occurrence of feeding was the first one from the initial instant, the elapsed time would start from zero.

In addition, optionally, the update also comprises adding an additive value to the multiplication, wherein the additive value is indicative of the time elapsed from zero until the currently determined occurrence of feeding. Specifically, the additive value is the first parameter. Alternatively, the first parameter may be zeroed during the threshold update, whereby the sum of the additive value is no longer executed.

In this way, the control unit 7 takes into account that the reducing solution in the reservoir 5 is renewed, despite still comprising the degraded base amount. The above subtraction takes precisely account of the deterioration of the base amount.

Then, after updating the threshold, the control unit 7 calculates the coefficient based on the acquired temperature, in association with the next value of the counter N (block 115 of FIG. 4).

The above (blocks 112-114 of FIG. 4) is performed if the occurrence of feeding is determined. Otherwise (output NO of block 111 of FIG. 4), the control unit 7 moves on directly to calculate the coefficient (block 115 of FIG. 4).

From here, the control unit 7 updates the first parameter by adding to the running time the product of the coefficient and of the sampling time (block 116 of FIG. 4).

Now, the control unit 7 compares the first updated parameter with the updated threshold (block 117 of FIG. 4).

If the first updated parameter is lower than or equal to the updated threshold (output YES of block 117), the control unit 7 moves on again and increments the counter N (block 108 of FIG. 4). Otherwise (output NO of block 118), the control unit 7 determines the critical condition (block 119 of FIG. 4).

It is worth reminding that FIG. 4 shows a particular non-limiting example of a method for monitoring the reducing solution, in particular over time; furthermore, all the steps represented by the blocks are to be considered as described independently of each other, whereby each of the blocks could be removed or replaced.

In summary, the control unit 7 is configured to perform the following steps of the monitoring method:
a) providing the first functional relationship,
b) acquiring the quantity, specifically the temperature of the reducing solution, and
c) determining the first parameter as a function of the acquired quantity via the first functional relationship.

The degradation state is monitored based on the first determined parameter. In general, the method also comprises the steps of:
d) determining the critical condition based on the first determined parameter, and more preferably
e) commanding the issue of a warning to the driver when the critical condition is determined.

The critical condition is determined when the first parameter satisfies a relationship with a threshold. In addition, further steps of the method could be:
f) determining the occurrence of feeding the additional amount of the solution into the reservoir,
g) determining the additional amount fed into the reservoir,
h) determining the base amount of the solution already in the reservoir just prior to the feeding of the additional amount, and
i) updating the threshold as a function of the determined additional amount and base amount.

From the foregoing, the advantages of the method and apparatus described above are evident.

The apparatus and the method allow a quantitative, reliable and, above all, repeatable evaluation of the degradation state of the reducing solution.

In this way, the driver can replenish or replace the reducing solution in the most appropriate moment, without risking inefficacy of the solution or waste.

In the case of replenishments, the method and the apparatus take into account the presence of the base amount, so that the evaluation of the degradation continues to be objective and reliable. In particular, the useful life of the reducing solution is not equal to that of a completely replaced solution but decreases as the base amount increases compared to the additional amount.

Finally, it is clear that modifications and variations can be made to the apparatus and method according to the invention without, however, departing from the scope of protection defined by the Claims.

For example, the apparatus could also operate outside the context of the vehicle 1.

In addition, the threshold could also be fixed; in this case, the first parameter would be variable as a function of the replenishments in a manner corresponding to what described. That is, the first parameter would be decreased as the threshold is increased as a function of the feeding of fresh reducing solution.

Similarly, the specific mathematical operations performed in updating the threshold could be different from those described in detail here, provided that the final result is still the same.
1-11. (canceled)

12. A method for monitoring a thermal degradation state of a reducing solution contained within a reservoir, the method comprising:
a) providing a first functional relationship associating a quantity indicative of a temperature of the solution with a first parameter associated with the thermal degradation state,
b) acquiring the quantity, and
c) determining the first parameter as a function of the acquired quantity via the first functional relationship,
wherein the degradation state is monitored based on the first determined parameter,
wherein the first parameter is a decay time of the solution, and
wherein the first functional relationship comprises an increasing function of a product between running time and an increasing coefficient with said quantity.

13. The method according to claim 12, further comprising:
d) determining (119) a critical condition of the degradation state based on the determined first parameter, and
wherein the critical condition is determined when the first parameter satisfies a relationship with a threshold.

14. The method according to claim 13, further comprising:
e) commanding an issue of a warning to a user when the critical condition is determined.

15. The method according to claim 13, further comprising:
f) determining an occurrence of feeding an additional amount of the solution into the reservoir,
g) determining the additional amount fed into the reservoir,
h) determining a base amount of the solution already in the reservoir just prior to the feeding of the additional amount, and
i) updating the threshold as a function of the determined additional amount and base amount.

16. The method according to claim 15, wherein step i) comprises a multiplication of the threshold by a sum of a first and a second value, wherein
the first value is indicative of a ratio of the base amount to a further sum of the base amount and the additional amount, and
the second value is indicative of a further ratio of the additional amount to the further sum.

17. The method according to claim 16, wherein step i) further comprises a subtraction of a product between the first value and a multiplicative factor to said multiplication, the multiplicative factor being indicative of an elapsed time up to the occurrence determined in step f) from a last occurrence of feeding prior to the occurrence of feeding determined in step f), or from zero in case of absence of said last occurrence of feeding.

18. The method according to claim 16, wherein step i) further comprises a sum of an additive value to the multiplication, the additive value being indicative of a further elapsed time from zero until the occurrence of feeding determined in step f).

19. The method according to claim 18, wherein the additive value is equal to the further time incremented as a function of the acquired quantity, in an increasing manner as the acquired quantity increases, wherein the acquired quantity is increasing with the temperature.

20. The method according to claim 12, wherein step a) comprises:
providing a second functional relationship associating the quantity with a second parameter associated with the thermal degradation state, such that the second parameter is decreasing as the quantity increases, and
providing a reference value of the second parameter associated with a value of the quantity representative of an ambient temperature,
providing a third parameter inversely proportional to the second parameter, at least for values of the quantity that are representative of temperatures greater than said ambient temperature, according to a proportionality constant defined by said reference value, and providing the first functional relationship as an increasing function of the third parameter.

21. The method according to claim 20, wherein the decay time is a running time from zero incremented as a function of the acquired quantity, in an increasing manner as the acquired quantity increases, wherein the acquired quantity is increasing with the temperature.

22. An apparatus for monitoring a thermal degradation state of a reducing solution contained within a reservoir, the apparatus comprising a control unit programmed to carry out the method according to claim 12.
